(19) United States
(12) Patent Application Publication
(10) Pub. No.: US 2014/0040903 A1
(43) Pub. Date: Feb. 6, 2014

(54) Queue and operator instance threads to losslessly process online input streams events

(71) Applicants: Meichun Hsu, Los Altos Hills, CA (US); Qiming Chen, Cupertino, CA (US)

(72) Inventors: Meichun Hsu, Los Altos Hills, CA (US); Qiming Chen, Cupertino, CA (US)

(21) Appl. No.: 13/562,691

(22) Filed: Jul. 31, 2012

(51) Int. Cl. G06F 9/50

(52) U.S. Cl. 718/103; 718/104

(57) ABSTRACT

A queue enqueues an online input stream of events arriving at the queue in real-time. An operator instance has one or more threads to losslessly dequeue and process the events from the queue, and to output processing results of the events in a common output stream. The one or more threads are dynamically instantiated and destantiated to maintain an optimal number of the one or more threads while ensuring that none of the events of the online input stream are dropped.

### BACKGROUND

Real-time stream analysis operates on real-time streams of data generated by a wide variety of different data sources. Examples of such data sources include physical sensors that generate measurements of physical attributes like temperature, humidity, and so on. Other examples of such data sources include stock market and other live business-oriented and/or financial-oriented data, as well as social media data, such as status updates generated by social networking users.

### BRIEF DESCRIPTION OF THE DRAWINGS

FIG. 1 is a diagram of an example system including a queue and an operator instance having multiple threads to losslessly process online input stream events.

FIG. 2 is a flowchart of an example method for losslessly processing online input stream events using a queue and an operator instance having multiple threads.

FIGS. 3A and 3B are flowcharts of different example methods for managing the multiple threads of an operator instance that together with a queue losslessly processes online input stream events.

FIG. 4 is a diagram of an example computing device that implements a queue and an operator instance having multiple threads to losslessly process online input stream events.

### DETAILED DESCRIPTION

As noted in the background section, real-time stream analysis operates on real-time streams of data, which encompass individually generated events. A real-time stream of data can also be referred to as an online stream of events, insofar as the stream is made up of discrete events of data and is generated by an online event source or generator, and thus in real-time, as compared to by an offline source or generator that generates such events in a non-real-time manner. The events of an online stream can be generated fairly constantly, or variably. A variably generated online stream, for instance, means that at some times many events are generated, whereas at other times not many or no events are generated.

In general, an operator instance or task is employed to consume the events of an online stream, and correspondingly process the events to generate an output stream of processing results. The operator instance is a stationary operator, which receives incoming events and correspondingly generates the output stream of processing results. If the arrival rate of the events becomes greater than the processing rate or throughput of the operator instance, the operator instance cannot keep up with the events, and some events will not be processed.

To handle this situation, two techniques are typically employed. First, multiple operator instances are instantiated. That is, parallelization of operator instances is employed. Each operator instance has its own output stream, and operates separately from the other operator instances. However, such parallelization can have distinct disadvantages. Where the arrival rate of the events is variable, at times there can be an insufficient number of generated events to keep all the operator instances busy. This means that some operator instances remain idle, which can waste processing and other hardware resources, like memory.

Furthermore, because the operator instances have their own output streams, the incoming data has to be partitioned in such a way that different types of events are handled by different operator instances. Such partitioning may be static, where each operator instance receives just events of the same type, and cannot subsequently be changed so that an operator instance can receive events of a different type. Some types of data events are not amenable to such partitioning, and it may also be difficult to predict beforehand the frequency at which different types of events are generated, such that some operator instances may still become overwhelmed while others remain underutilized.

A second technique is controlled load shedding. Controlled load shedding means that events are dropped, not reactively because an operator instance can no longer accommodate the arrival rate of the events, but proactively to prevent the operator instance from becoming so overwhelmed. For instance, the events may be sampled in accordance with a particular approach so that the events that are processed by the operator instance are representative of the online stream as a whole. However, some types of online streams cannot be processed in such a lossy manner, but rather have to be processed losslessly, limiting the usefulness of controlled load shedding.

By comparison, techniques disclosed herein losslessly process online input stream events without parallelizing multiple operator instances. A queue enqueues an online input stream of events that arrive at the queue in real-time. An operator instance can have multiple threads to losslessly dequeue and process the events from the queue, and to output the processing results in an output stream common to the threads. The threads can be dynamically instantiated and destantiated so that there are an optimal number of the threads while ensuring that no events are dropped.

Such techniques disclosed herein do not require data partitioning of the input stream of events, and thus can be used even for input streams that resist static partitioning in particular. Such techniques similarly do not perform load shedding, since the techniques are lossless, and therefore can be used for input streams that cannot be or are optimally not processed in a lossy manner. The techniques disclosed herein, in other words, avoid the shortcomings and pitfalls associated with operator instance parallelization and load shedding, by having multiple threads within a given operator instance instead of multiple operator instances, without load shedding.

Furthermore, an input stream can be skewed. That is, events can arrive at a variable rate. The techniques disclosed herein ensure that no events are lost, but in an efficient manner. Specifically, processing resources are not wasted, since resources do not have to be allocated to handle an upper or maximum arrival rate of events. Indeed, in some scenarios, the upper bound such as the event arrival rate may not be able to be predicted or known beforehand.

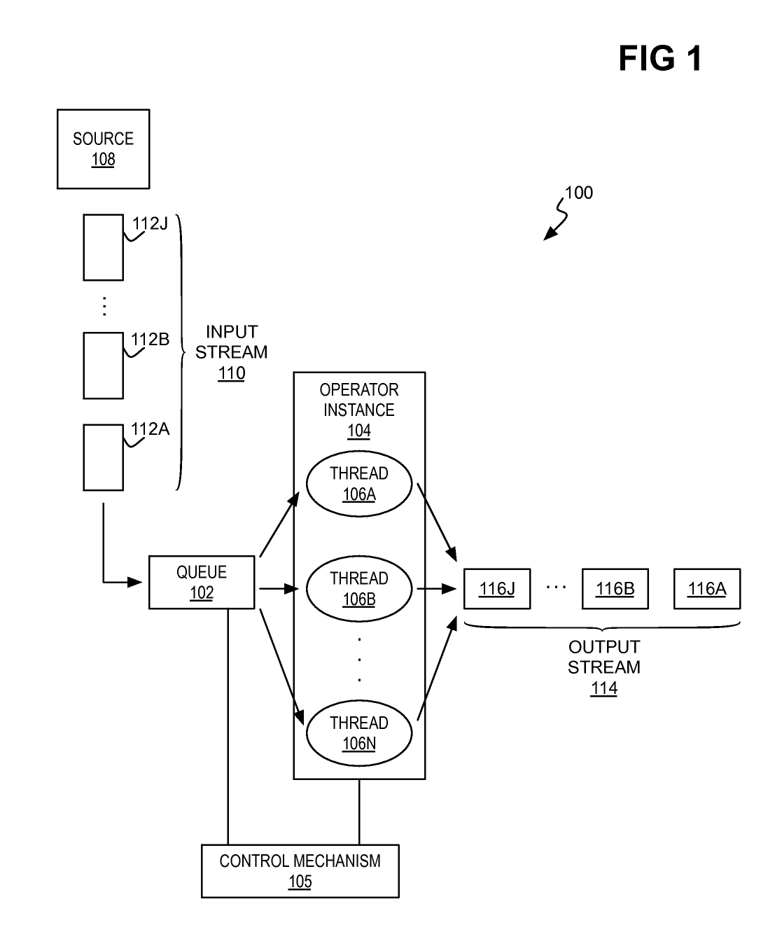

FIG. 1 shows an example system 100. The system 100 includes a queue 102, an operator instance 104, and a control mechanism 105. The system 100 may be implemented over one or more computing devices, as is described in more detail later in the detailed description.

The queue 102 in one implementation has a static size, which does not dynamically vary after being set. The queue 102 can be implemented in volatile memory, such as dynamic random-access memory. The operator instance 104 is an instance of a software component like a module, computer program, or object. An instance may also be referred to as a task or a process. The instance 104 includes a dynamically variable number of one or more threads 106A, 106B, . . . , 106N, which are collectively referred to as the threads 106. The control mechanism 105 is a software component as well, and monitors the queue 102 and/or the operator instance 104, to responsively dynamically instantiate and destantiate the threads 106.

The difference between a thread and an instance, or process, is as follows. Processes are independent of one another, whereas threads exist as subset of a process. A process carries considerably more state information than threads do. By comparison, multiple threads within a process share process state as well as memory and other resources. Whereas processes have separate memory address spaces, threads share their address space. Processes interact just through system-provided inter-process communication mechanisms, whereas threads of the same process communicate on an intra-process manner. Processor context switching between threads in the same process is typically faster than context switching between processes as well.

The threads 106 of the instance 104 can be multithreaded. This means that the threads 106 share the resources of the instance 104, but execute independently. Such a threading programming model provides an abstraction of concurrent execution. Multithreading is particularly useful in the context of a processor that has multiple cores, or in the context of multiple computing devices, which permits true concurrent execution to occur. By comparison, for a single-core processor, multithreading can still be achieved, but occurs by time multiplexing the available core of the processor among the threads 106 of the instance 104.

A data source or generator 108 generates an online input stream 110 of events 112A, 112B, . . . , 112J, collectively referred to as the events 112. Each event 112 is a discrete collection or set of data. The events 112 may be of the same or different type. For instance, in the context of social networking, the events 112 may be status updates of the same or different individuals, photo or video uploads, and so on. The events 112 can have a variable arrival rate at the queue 102, which means that during some periods of time a large number of events 112 may arrive at the queue 102, whereas during other periods of time a small number of events 112, or no events 112, may arrive at the queue 102.

The queue 102 has a very low latency, such as a latency less than the arrival rate of the online input stream 110 of events 112 even at a maximum arrival rate thereof. As noted above, the queue 102 can have a static size, such as regardless of the variable arrival rate of the events 112. The queue 102 separates the threads 106 of the operator instance 104 from the input stream 110 of events 112. That is, the threads 106 do not directly receive the events 112, but rather the events 112 are first enqueued within the queue 102, and then dequeued by the threads 106 of the operator instance 104.

Furthermore, the queue 102 can be an in-task queue. That is, the queue 102 is part of a task inclusive of the threads 106. As such, the queue 102 is not implemented in these situations outside of the task. Such a queue 102 is different than a typical scheduling queue, and permits in-task threads 106 to be launched dynamically and on-the-fly, to provide for increased parallelism, particularly with modern multiple-core processors, without having to change a partition scheme over multiple tasks.

The threads 106 dequeue the events 112 of the online input stream 110 asynchronously in relation to the arrival of the events at the queue 102. When the events 112 arrive at the queue 102 faster than the threads 106 can process the events 112, the events 112 build up within and fill up the queue 102. When the events 112 arrive at the queue 102 at a slower rate, the threads 106 may be able to remove the events 112 from the queue 102 as fast as the events 112 arrive at and are added to the queue 102.

The threads 106 process the events 112 as the events 112 of the online input stream 110 are removed from the queue 102 by the threads 106. In general, a thread 106 removes the next event 112 from the queue 102 on a first-in, first-out basis, processes the event 112, and outputs a processing result thereof within an output stream 114 of processing results 116A, 1168, . . . , 116J, collectively referred to as the processing results 116. The processing results 116 can correspond to the events 112 on a one-to-one basis, such that each event 112 has a corresponding processing result 116 within the output stream 114.

The threads 106 operate in parallel to one another. However, the processing results 116 are ordered within the output stream 114 in the same order in which their corresponding events enter and exit the queue 102. The output stream 114 is common to the threads 106, as opposed to each thread 106 having its own output stream. Therefore, no new data partitioning of the events 112 within the online input stream 110 has to be effectuated, in contradistinction to instance parallelization techniques.

The threads 106 are thus inside the same execution framework of the operator instance 104, which can be a single or only instance 104 of the operator in question, to provide a corresponding single or only output stream 114 in one implementation. The operator instance 104 of which the threads 106 are a part and that operate within the framework thereof defines the type of processing that each thread 106 performs. The threads 106 each perform the same type of processing, such that it does not matter which thread 106 dequeues which event 112 from the queue 102. Rather, a greedy methodology can be employed, where an available thread 106 consumes the next event 112 from the queue 102 and processes the event 112 to generate a corresponding processing result 116.

The control mechanism 105 monitors the queue 102 and/or the operator instance 104 and its constituent threads 106 to dynamically instantiate and destantiate the threads 106 as appropriate to maintain an optimal number of the threads 106 while ensuring that no event 112 is dropped. In this way, the dequeuing and processing of the events 112 from the queue 102 by the threads 106 of the operator instance 104 is lossless. As such, the disclosed techniques are in contradistinction with controlled load shedding techniques in which events are purposefully dropped.

For instance, if the queue 102 is becoming too full, the control mechanism 105 can instantiate more threads 106, and destantiate the threads 106 once the queue 102 becomes less full again. That is, in such an implementation, the control mechanism 105 increases the number of threads 106 as the fullness of the queue 102 increases, and decreases the number of threads 106 as the fullness of the queue 102 decreases. As another example, the control mechanism 105 may instantiate and destantiate threads 106 in accordance with the arrival rate of the events 112 at the queue 102. As the arrival rate of the events 112 increases, the control mechanism 105 increases the number of threads 106 in this implementation, and as the arrival rate decreases, the mechanisms 105 decreases the number of threads 106.

This technique ensures that resources of the underlying hardware that effectuates the example system 100 are employed efficiently. Threads 106 that are idle can be destantiated so as not to use such hardware resources. When the queue 102 begins to fill up again, and/or when the arrival rate of the events 112 at the queue 102 begins to again increase, more threads 106 can be instantiated at that time to handle the surge in events 112 to ensure that no events 112 are dropped.

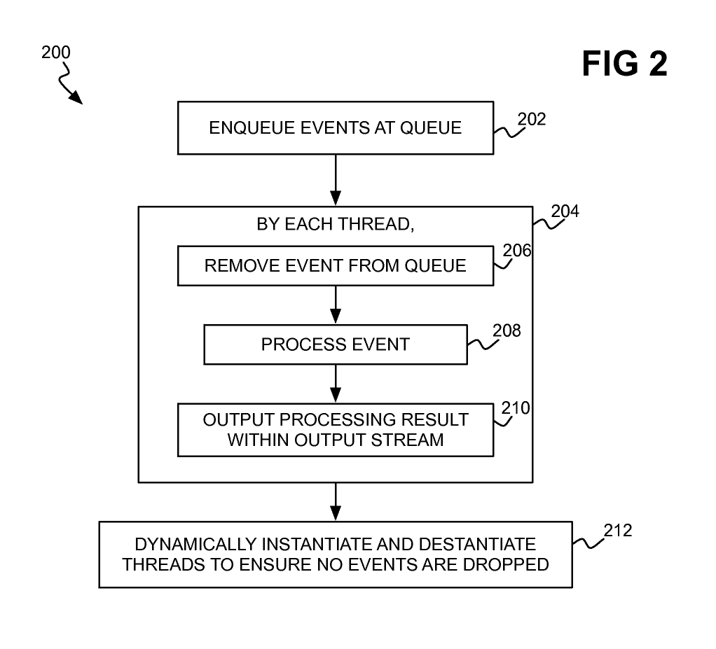

FIG. 2 shows an example method 200 of operation of the example system 100. As with other methods disclosed herein, the example method 200 can be implemented as a computer program executable by a processor. The computer program may be stored on a non-transitory computer-readable data storage medium. Examples of such computer-readable media include volatile and non-volatile media like hard disk drives, semiconductor memory, and the like.

The events 112 of the input stream 110 generated by the data source 108 are enqueued at (i.e., added to) the queue 102 (202). The following is then performed by each thread 106 of the operator instance 104 that is current instantiated (204). An event 112 is removed (i.e., dequeued) from the queue 102 (206), and processed (208). The event 112 that is removed from the queue 102 and processed is the next event 102 within the queue 102, which is the oldest event 112 within the queue 102. The processing result 116 of the event 112 is placed or output within the output stream 114 of processing results 116 (210). As noted above, the output stream 114 is common to the threads 106 of the operator instance 104, and the processing results 116 are ordered within the output stream 114 in correspondence with the order of the online input stream 110 of the events 112 themselves.

The control mechanism 105 dynamically instantiates and destantiates threads 106 within the operator instance 104 to ensure that no events 112 within the online input stream 110 are dropped (212). In this respect, the control mechanism 105 may be considered as an external or an internal mechanism to the operator instance 104 itself. That is, in one implementation, the control mechanism 105 and its logic are external to the operator instance 104, whereas in another implementation, the mechanism 105 and its logic are internal to and part of the instance 104.

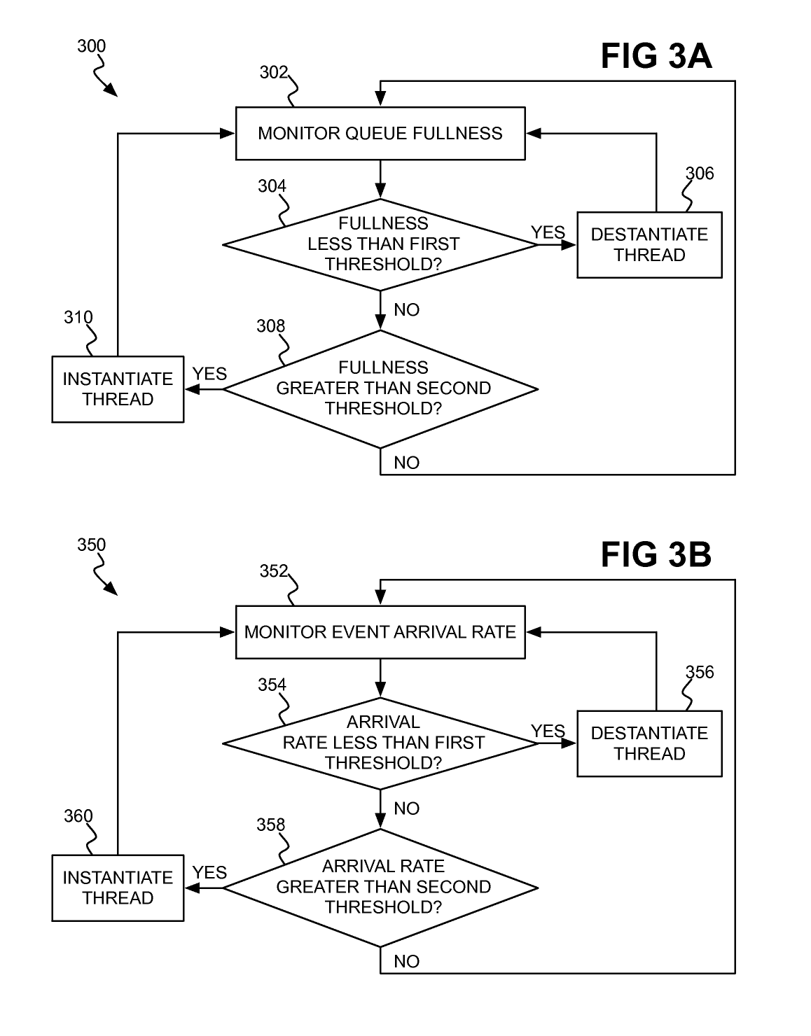

FIGS. 3A and 3B show different example methods 300 and 350, respectively, for dynamically instantiating and destantiating the threads 106 of the operator instance 104 in part 212 of the method 200. In the method 300 of FIG. 3A, the control mechanism 105 periodically or continually monitors the fullness of the queue 102 (302). If the fullness is less than a first threshold (304), then an existing thread 106 is destantiated from the operator instance 104 (306), and the method 300 repeats at part 302. If the fullness by comparison is greater than a second threshold (308), then a new thread 106 is instantiated to the operator instance 104 (310), and the method 300 repeats at part 302.

The method 300 thus operates to ensure that the queue 102 maintains a fullness between the first threshold and the second threshold. If the fullness drops below the first threshold, then threads 106 are removed from the operator instance 104, such that the queue 102 may then fill up with events 112. If the fullness rises above the second threshold, then threads 106 are added to the operator instance 104, such that events 112 may be depleted from the queue 102 more quickly. The first and second thresholds may be 20% and 80%, respectively, of the total size of the queue 102. The minimum number of threads 106 within the operator instance 104 may be as little as no threads 106, and the maximum number of threads 106 within the operator instance 104 may be unlimited, or set to a predetermined number, such as equal to the number of processing cores of the processor(s) on which the example system 100 is effectuated.

In the method 350 of FIG. 3B, the control mechanism 105 periodically of continually monitors the arrival rate of the events 112 of the online input stream 110 at the queue 102 (352). If the arrival rate is less than a first threshold (354), then an existing thread 106 is destantiated from the operator instance 104 (356), and the method 350 repeats at part 352. If the arrival rate by comparison is greater than a second threshold (358), then a new thread 106 is instantiated to the operator instance 104 (360), and the method 350 repeats at part 352.

Both the methods 300 and 350 operate to ensure that there are a sufficient number of threads 106 within the operator instance 104 to process the events 112 of the online input stream 110 without any events 112 being dropped, while at the same time ensuring that there are not an undue number of threads 106 that are idle and consuming resources but not processing events 112. That is, it can be said that an optimal number of threads 106 is maintained within the operator instance 104, by instantiating and destantiating threads 106 as appropriate. In the method 350 in particular, the first and second thresholds may be 20% and 80%, respectively, of the maximum arrival rate of events 112 at the queue 102.

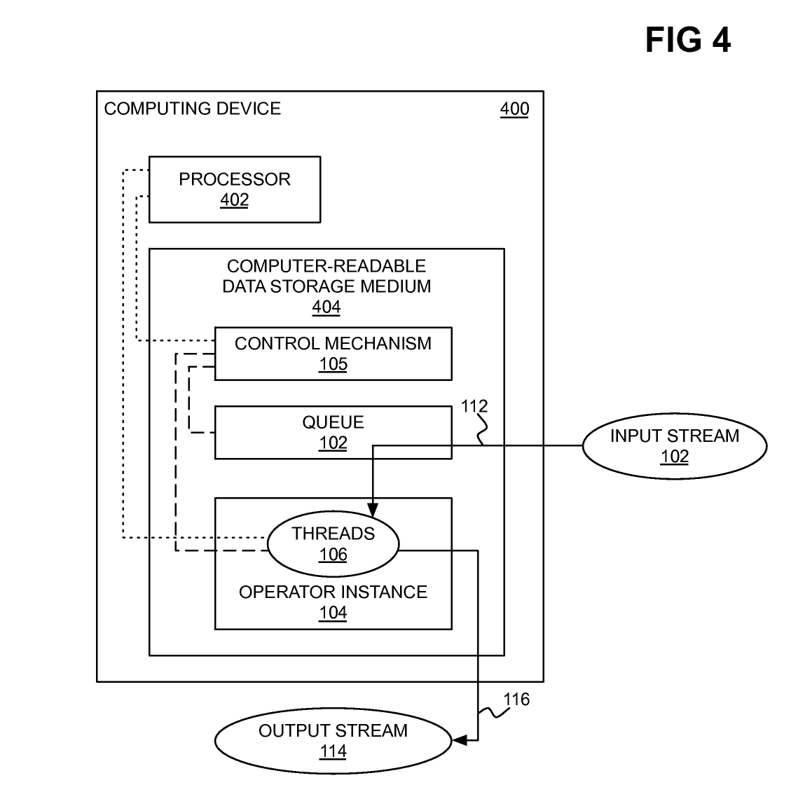

FIG. 4 shows an example computing device 400 that can implement the example system 100 that has been described. The computing device 400 can be a desktop or a laptop computer, or another type of computing device. The computing device 400 includes a processor 402 and a computer-readable data storage medium 404. The computing device 400 can and typically does include other hardware components, in addition to the processor 402 and the computer-readable data storage medium 404.

The processor 402 can be a multiple-core processor. The multiple cores can be virtual and/or physical cores. As one example, the processor 402 may have four physical cores, each of which can implement two virtual cores, for a total of eight virtual cores within the processor 402. Dotted lines between the processor 402 and the control mechanism 105 and the threads 106 in FIG. 4 denote that the processor 402 implements or processes the mechanism 105 and each thread 106. For example, each thread 106, as well as the control mechanism 105, may be accorded its own processor core, be it a virtual core or a physical core.

The computer-readable data storage medium 404 can be a volatile or a non-volatile medium, as described above. The computer-readable data storage medium 404 stores the data structure that makes up the queue 102, and the computer program, module, component and/or object(s) that make up the control mechanism 105 and the operator instance 104, including the multiple threads 106 of the operator instance 104. As such, the processor 402 executes the control mechanism 105 and the threads 106 of the operator instance 104 from and/or as stored on the computer-readable data storage medium 404.

Solid lines denote the processing flow that occurs within FIG. 4. The online input stream 102 is enqueued at the queue 102, and then individual events 112, represented as a solid line in FIG. 4, are dequeued by the threads 106 of the operator instance 104 and processed. The processing results 116, which are also represented as a solid line in FIG. 4, are then output by the threads 106 as the output stream 114.

Dashed lines within FIG. 4 denote the monitoring and other functionality that the control mechanism 105 performs in relation to the queue 102 and/or the threads 106 of the operator instance 104. Specifically, the control mechanism 105 can monitor the queue 102 as has been described. The control mechanism 105 also instantiates new threads 106 within the operator instance 104, and destantiates existing threads from the operator instance 104.

We claim:

1. An apparatus comprising:
a processor;
a computer-readable data storage medium;
a queue implemented by the processor at the computer-readable data storage medium to enqueue an online input stream of events arriving at the queue in real-time;
an operator instance implemented by the processor and having one or more threads to losslessly dequeue and process the events from the queue, and to output processing results of the events in a common output stream; and
a control mechanism implemented by the processor to dynamically instantiate and destantiate the one or more threads to maintain an optimal number of the one or more threads while ensuring that none of the events of the online input stream are dropped.

2. The apparatus of claim 1, wherein the queue has a static size regardless of a variable arrival rate of the events at the queue.

3. The apparatus of claim 1, wherein the events arrive at the queue at a variable arrival rate, such that the control mechanism is to decrease a number of the one or more threads as the variable arrival rate of the events at the queue decreases and is to increase the number of the one or more threads as the variable arrival rate of the events at the queue increases.

4. The apparatus of claim 1, wherein the one or more threads dequeue and process the events asynchronously in relation to arrival of the events at the queue.

5. The apparatus of claim 1, wherein each thread upon becoming available dequeues a next event from the queue, processes the next event, and outputs a processing result of the next event in the common output stream in coordination with other threads of the one or more threads, such that the processing results within the common output stream are ordered in accordance with an order in which the events are enqueued within the queue,
and wherein the common output stream is common to each thread.

6. The apparatus of claim 1, wherein the control mechanism is to monitor a fullness of the queue, is to increase the number of the one or more threads as the fullness of the queue increases, and is to decrease the number of the one or more threads as the fullness of the queue decreases.

7. The apparatus of claim 1, wherein the operator instance is a single and only operator instance to dequeue and process the events of the online input stream, and the common output stream is a single and only output stream in which the processing results of the events of the online input stream are output.

8. A method comprising:
adding to a queue an online input stream of events arriving at the queue in real-time;
by each thread of one or more threads of an operator instance,
removing a next event from the queue;
processing the next event removed from the queue; and
outputting a processing result of the next event within an output stream common to the one or more threads,
wherein the events are losslessly added to and removed from the queue.

9. The method of claim 8, wherein removing the next event from the queue, processing the next event removed from the queue, and outputting the processing result of the next event within the output stream are performed asynchronously in relation to arrival of the events at the queue.

10. The method of claim 8, further comprising:
dynamically instantiating and destantiating the one or more threads to maintain an optimal number of the one or more threads while ensuring that none of the events of the online input stream are dropped,
wherein the events arrive at the queue at a variable arrival rate, such that a number of the one or more threads is decreased as the variable arrival rate decreases and is increased as the variable arrival rate increases.

11. The method of claim 10, further comprising:
monitoring fullness of the queue, such that the number of the one or more threads is increased as the fullness increases and is decreased as the fullness decreases.

12. The method of claim 8, wherein the operator instance is a single and only operator instance to dequeue and process the events of the online input stream, and the common output stream is a single and only output stream in which the processing results of the events of the online input stream are output.

13. A non-transitory computer-readable data storage medium storing a computer program executable by a processor to perform a method comprising:
adding and removing threads of an operator instance that losslessly dequeue and process events of an online input stream that arrive at and are enqueued within a queue in real-time, to maintain an optimal number of the threads while ensuring that none of the events of the online input stream are dropped,
wherein the threads output processing results in a common output stream.

14. The non-transitory computer-readable data storage medium of claim 13, wherein the events arrive at the queue at a variable arrival rate,
and wherein adding and removing the threads of the operator instance comprises decreasing a number of the threads as the variable arrival rate decreases and increasing the number of the threads as the variable arrival rate increases.

15. The non-transitory computer-readable data storage medium of claim 13, wherein the method further comprises:
monitoring a fullness of the queue,
and wherein adding and removing the threads of the operator instance comprises increasing a number of the threads as the fullness increases and decreasing the number of the threads as the fullness decreases.
